(19) United States
(12) Patent Application Publication
(10) Pub. No.: US 2010/0074196 A1
(43) Pub. Date: Mar. 25, 2010

(54) Connection Addressing for Wireless Communications

(75) Inventor: Hua Mary Chion, Belle Mead, NJ (US)

Correspondence Address: FISH & RICHARDSON, PC, P.O. BOX 1022, MINNEAPOLIS, MN, 55440-1022, US

(73) Assignee: ZTE (USA) Inc.

(21) Appl. No.: 12/506,220

(22) Filed: Jul. 20, 2009

Related U.S. Application Data
(60) Provisional application No. 61/082,177, filed on Jul. 18, 2008.

(51) Int. Cl. H04W 72/00; H04W 4/00

(52) U.S. Cl. 370/329; 455/422.1

(57) ABSTRACT

Systems, apparatuses, and techniques can include using a mobile station identifier to identify a mobile station associated with a base station in wireless communications between the mobile station and the base station, using a connection identifier and the mobile station identifier to identify a connection between the mobile station and the base station; and transacting information with a radio station. The information can include the connection identifier, the mobile station identifier, and data associated with the connection.

### CROSS REFERENCE TO RELATED APPLICATION

This document claims the benefit of the priority of U.S. Provisional Application Ser. No. 61/082,177, filed Jul. 18, 2008 and entitled “Connection Addressing for Wireless Communications,” the entire contents of which are hereby incorporated by reference.

### BACKGROUND

This application relates to wireless communication techniques and wireless communication systems, including wireless communication systems based on orthogonal frequency division multiplexing (OFDM) and orthogonal frequency division multiple access (OFDMA).

Wireless communication systems use a network of base stations to communicate with wireless devices registered for services in the systems. For example, such systems can include a network of one or more base stations to communicate with one or more wireless devices such as a mobile device, cell phone, wireless air card, a wireless station, user equipment (UE), access terminal (AT), or subscriber station (SS). A wireless device can be referred to as a mobile station (MS) or a mobile subscriber station. A wireless communication system can be referred to as a wireless network.

A base station (BS) can emit radio signals that carry data such as voice data and other data content to wireless devices. Such a signal from a base station can include information for various communication management functions, including information to allow a wireless device to identify a cell sector of a base station, to synchronize signaling in time and frequency. A wireless device can processes such information prior to processing of payload data.

A base station and a wireless device can wirelessly communicate using one or more wireless air interface technologies such as orthogonal frequency division multiplexing (OFDM) and orthogonal frequency division multiple access (OFDMA). Some wireless communication systems can operate in accordance with an IEEE 802.16 specification, such as IEEE 802.16e-2005. Some wireless communication systems can operate in accordance with 3GPP2 and 3GPP specifications. Various examples of air interface technologies include wireless interoperability for microwave access (WiMAX), Code Division Multiple Access (CDMA), CDMA2000, High Rate Packet Data (HRPD), and Universal Mobile Telecommunications System (UMTS) technologies.

### SUMMARY

This document describes technologies, among other things, for connection addressing in wireless communication systems.

In one aspect, techniques for wireless communication can include using a mobile station identifier to identify a mobile station associated with a base station in wireless communications between the mobile station and the base station, using a connection identifier and the mobile station identifier to identify a connection between the mobile station and the base station; and transacting information with a radio station. The information can include the connection identifier, the mobile station identifier, and data associated with the connection. Other implementations can include corresponding systems, apparatus, and computer programs, configured to perform the actions of the techniques, encoded on computer readable mediums.

These and other implementations can include one or more of the following features. Transacting information with the radio station can include transacting information in a frame. The information can include a downlink map that includes the mobile station identifier; and a data burst that includes the connection identifier in a header portion, and data associated with the connection in a payload portion. The downlink map can include information that corresponds to a location of the data burst within the frame. Some implementations can use a second connection identifier and the mobile station identifier to identify a second connection between the mobile station and the base station, wherein the transacted information comprises data payload associated with the second connection and the second connection identifier in a header associated with the data payload. The radio station can be a mobile station and can be identified by the mobile station identifier. Transacting information can include receiving a signal that includes the information. The radio station can be a base station. Transacting information can include transmitting a signal that includes the information to one or more mobile stations.

These and other implementations can include using a different mobile station identifier as a broadcast identifier to identify broadcast traffic. Some implementations can include using a connection identifier associated with a broadcast channel and the broadcast identifier to identify the broadcast channel. Transacting information with the radio station can include transacting, in a frame, information including a downlink map that includes the broadcast identifier and a data burst. The data burst can include the connection identifier associated with the broadcast channel in a header portion and data associated the broadcast channel in a payload portion. The downlink map can include information that corresponds to a location of the data burst within the frame.

In another aspect, techniques for wireless communication can include providing in a Media Access Control (MAC) layer connection address a mobile station identifier (MS ID) that represents and identifies a mobile station to a base station of a wireless network, each mobile station in communication with the base station being provided with a respective mobile station identifier; providing a connection identifier (CON ID) that identifies a connection between the mobile station and the base station to carry a data flow and is a separate identifier from the MS ID for the mobile station for communications with the base station, each connection between the mobile station and the base station being provided with a respective connection identifier; and using a combination address comprising the MS ID and the CON ID to represent the connection between the mobile station and the base station. Other implementations can include corresponding systems, apparatus, and computer programs, configured to perform the actions of the techniques, encoded on computer readable mediums.

These and other implementations can include one or more of the following features. Some implementations can use a second combination address to represent a second connection between the mobile station and the base station to identify an additional data flow. The second combination address can include the MS ID and a second CON ID. Some implementations can include in a downlink map the MS ID and frame location information regarding one or more data bursts that are associated with the MS ID, at least one of the one or more data bursts can include the CON ID. Some implementations can include transmitting a signal to one or more mobile stations, the signal comprising the downlink map and the one or more data bursts.

These and other implementations can include providing a specific mobile station identifier as a broadcast identifier to represent broadcast traffic from the base station to multiple mobile stations, the broadcast identifier being shared by the multiple mobile stations. Some implementations can include providing a broadcast channel connection identifier that identifies a broadcast channel and is a separate identifier from the broadcast identifier. Some implementations can include using a combination address comprising the broadcast identifier and the broadcast channel connection identifier to represent the broadcast channel. Some implementations can include providing a second broadcast channel connection identifier that identifies a second broadcast channel and is a separate identifier from the broadcast identifier. Some implementations can include using a second combination address comprising the broadcast identifier and the second broadcast channel connection identifier to represent a different broadcast channel.

These and other implementations can include providing a specific mobile station identifier as a mutlicast identifier to represent mutlicast traffic from the base station to multiple mobile stations. Some implementations can include providing a mutlicast channel connection identifier that identifies a mutlicast channel and is a separate identifier from the mutlicast identifier. Some implementations can include using a combination address comprising the mutlicast identifier and the mutlicast channel connection identifier to represent the mutlicast channel to a group of mobile stations. Some implementations can include providing a second mutlicast channel connection identifier that identifies a second mutlicast channel and is a separate identifier from the mutlicast identifier. Some implementations can include using a second combination address comprising the mutlicast identifier and the second mutlicast channel connection identifier to represent a different mutlicast channel.

In yet another aspect, wireless communication systems can include a plurality of base stations configured to provide wireless service. A base station can be configured to use a mobile station identifier to identify a mobile station associated with the base station in wireless communications between the mobile station and the base station. The base station can be configured to use a connection identifier and the mobile station identifier to identify a connection between the mobile station and the base station. The base station can be configured to transmit a signal to the mobile station. The signal can include the connection identifier, the mobile station identifier, and data associated with the connection.

In yet another aspect, apparatuses and systems for wireless communications can include transceiver electronics to communicate with one or more radio stations; and processor electronics, in communication with the transceiver electronics, configured to perform operations described herein.

The details of one or more implementations are set forth in the accompanying attachments, the drawings, and the description below. Other features will be apparent from the description and drawings, and from the claims.

### BRIEF DESCRIPTION OF THE DRAWINGS

FIG. 1A shows an example of a wireless communication system.

FIG. 1B shows an example of a radio station architecture.

FIG. 2 shows an example of wireless communications where a different connection identifier is assigned to each connection.

FIG. 3 shows an example of a header format used in communications shown by FIG. 2.

FIG. 4 shows an example of a connection addressing technique that uses a mobile station identifier.

FIG. 5 shows an example of a frame that includes mobile station and connection identifiers.

FIG. 6 shows an example of a downlink map information element that includes a mobile station identifier.

FIG. 7 shows an example of a MAC header format that includes a CON ID field.

FIG. 8 shows an example of an addressing scheme that uses a mobile station identifier as a broadcast identifier.

FIG. 9 shows an example of a connection addressing technique for wireless communications between radio stations.

FIG. 10 shows a different example of a connection addressing technique for wireless communications between radio stations.

Like reference symbols in the various drawings indicate like elements.

### DETAILED DESCRIPTION

This document describes implementations for efficient connection addressing in wireless networks. Such efficient connection addressing can be used in various wireless communication systems, including OFDM and OFDMA systems.

Wireless OFDM and OFDMA based communication systems are based on the orthogonality of frequencies of multiple subcarriers and can be implemented to achieve a number of technical advantages for wideband wireless communications, such as resistance to multipath fading and interference. In some OFDM or OFDMA based wireless communication systems, the wireless service to a geographic area is provided by dividing the area into a plurality of cells, which can be further divided into two or more cell sectors. Base stations, which conceptually locate at the center of respective cells of their coverage, can transmit information to a mobile station via downlink radio signals sent out from the base stations. Mobile stations can transmit information to their serving base stations via uplink radio signals.

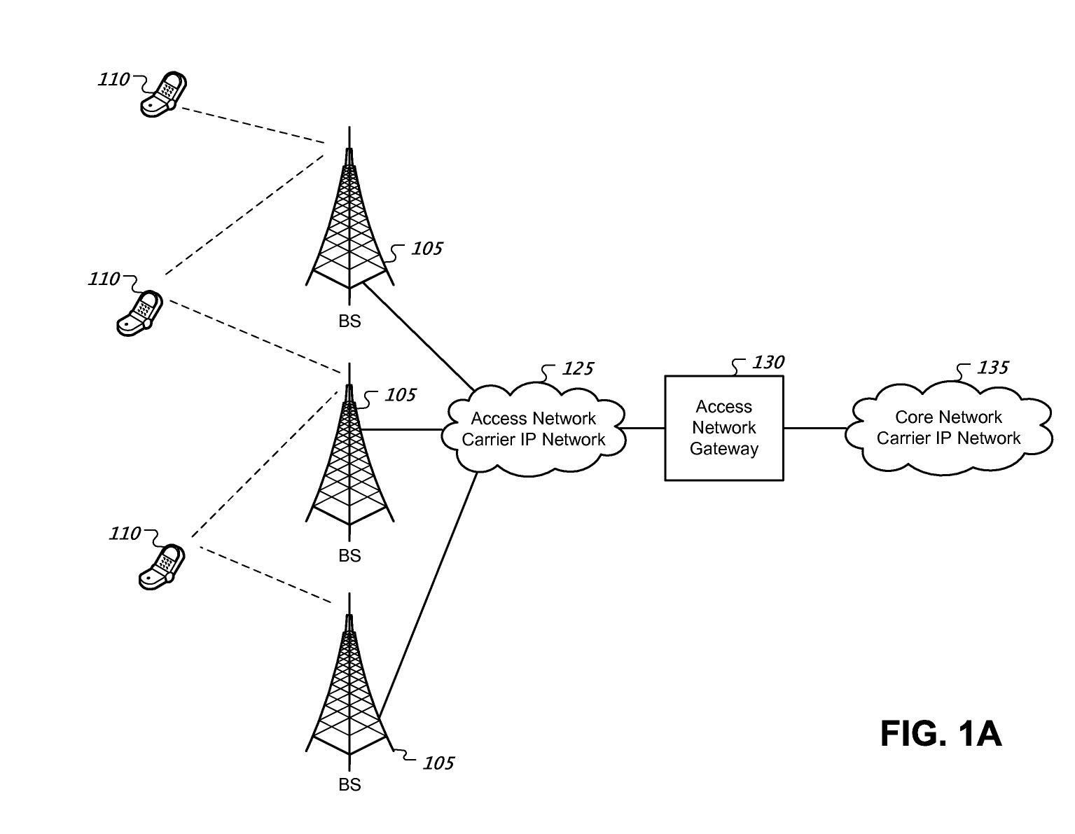

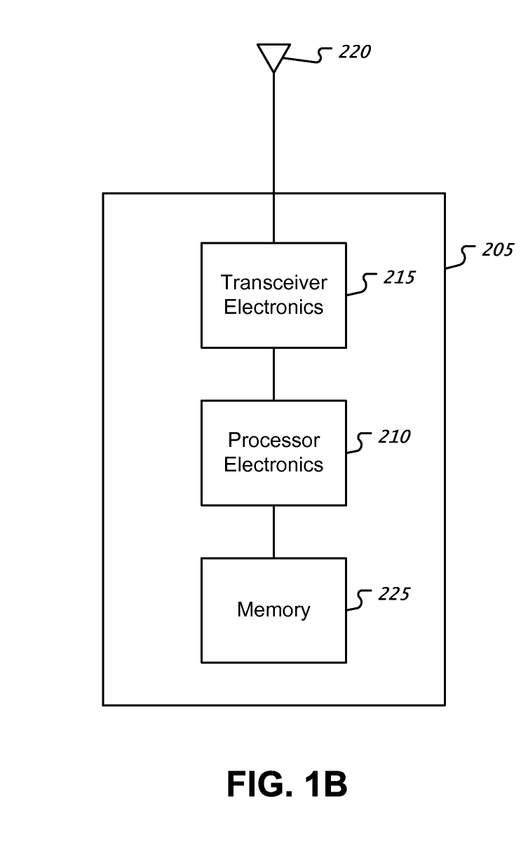

FIG. 1A shows an example of a wireless communication system. The techniques described herein can be implemented in a system such as the one shown in FIG. 1A. A wireless communication system can include one or more base stations (BSs) 105 and one or more wireless devices 110. Some wireless systems can refer to a base station as an access point. A base station 105 can transmit a signal on a forward link (FL), called a downlink (DL) signal, to one or more wireless devices 110. A wireless device 110 can transmit a signal on a reverse link (RL), called an uplink (UL) signal, to one or more base stations 105.

Base stations 105 and wireless devices 110 can communicate with each other using wireless technology such as OFDM and OFDMA. In some implementations, base stations 105 and wireless devices 110 can communicate using a wireless technology such as WiMAX. Some wireless communication systems can use one or more wireless technologies such as Worldwide Interoperability for Microwave Access (WiMAX), Long-Term Evolution (LTE), Code division Multiple Access (CDMA) such as

CDMA2000 1x, High Rate Packet Data (HRPD), and Universal Mobile Telecommunications System (UMTS).

A wireless communication system can include an access network 125, an access network gateway 130, and a core network 135. Access network 125, access network gateway 130, and core network 135 can use one or more networks such as a carrier IP networks for communications.

FIG. 1B shows an example of a radio station architecture. Various examples of radio stations include base stations and wireless devices. A radio station 205 such as a base station or a wireless device can include processor electronics 210 such as a microprocessor that implements methods such as one or more of the techniques presented in this document. A radio station 205 can include transceiver electronics 215 to send and/or receive wireless signals over one or more communication interfaces such as one or more antennas 220. A radio station 205 can include other communication interfaces for transmitting and receiving data. In some implementations, a radio station 205 can include one or more wired communication interfaces to communicate with a wired network. A radio station 205 can include one or more memories 225 configured to store information such as data and/or instructions. In some implementations, processor electronics 210 can include at least a portion of transceiver electronics 215 and a memory 225.

In various applications, various wireless communication systems can be based on packet switching networks instead of circuit switch networks. Some packet switching networks do not allocate dedicated physical channels to a mobile station or the data streams carried by the mobile station over a radio link. Instead, in some wireless networks, several mobile stations can share a physical channel to communicate with the network.

In some wireless networks, the communication channels between mobile stations and a base station can be identified at a Media Access Control (MAC) layer by using a connection identifier. In such wireless networks, multiple data streams can be carried between a mobile station and a base station, and multiple connection identifiers can assigned to the mobile station to identify each data stream. A MAC layer data packet, e.g., a protocol data unit (PDU), can include a connection identifier in a header to allow a recipient to differentiate data flows in the packet. In some wireless networks, such as ones based on IEEE 802.16e-2005, the connection identifier can be locally unique to a base station and can be used to identify a connection in the base station regardless of a mobile station's identity. The connection can carry information such as a data flow, data stream, or a service flow.

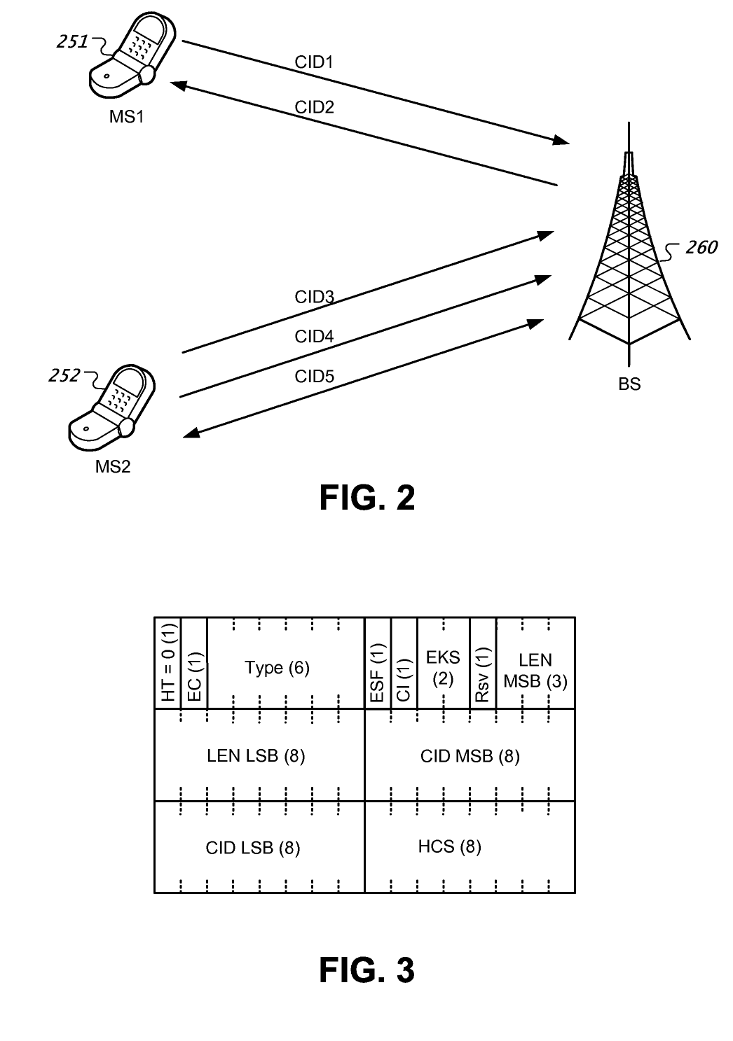

FIG. 2 shows an example of wireless communications where a different connection identifier is assigned to each connection. In this example, a connection identifier is unique over multiple MSs 251, 252, associated with a BS 260. In FIG. 2, a connection identifier is denoted as CIDx (e.g., CID1, CID2, CID3, CID4, and CID5) and is unique to the BS 260, with each connection identifier corresponding to a connection in the BS 260. Hence, the BS 260 can identify a mobile station 251, 252 associated with a connection based on the connection identifier. Some wireless networks can use a large number of CIDs to ensure the uniqueness of a connection identifier within a BS, which can lead to a long CID field length, e.g., 16 bits, and corresponding bandwidth to transmit CIDs over the air. Such wireless networks can include such a CID in each MAC layer PDU header, which may increase the amount of overhead in wireless communications.

FIG. 3 shows an example of a header format used in communications shown by FIG. 2. The header format is in accordance with IEEE 802.16e-2005 and can include a connection identifier field that is 16 bits in length. In this example, a MAC header can include the following fields: header type (HT), encryption control (EC), payload type, extended subheader flag (ESF), cyclic redundancy check (CRC) indicator (CI), encryption key sequence (EKS), payload length (LEN), connection identifier (CID), and a header check sequence (HCS). In this example, a value such as LEN or CID can be divided into two or more fields such as a most significant bits (MSB) portion field of the value and a least significant bits (LSB) portion field of the value.

This document includes details and examples of connection addressing techniques such as MAC layer connection addressing techniques that reduce overhead in wireless communications in comparison to some other wireless networks. A connection addressing technique can use a connection identifier and a mobile station identifier to identify and represent connections in wireless communications between mobile stations and base stations. A connection addressing technique can use a mobile station identifier (MS ID) to identify an active MS associated with a BS. A mobile station identifier can be unique within a BS. A connection addressing technique can associate a connection identifier with a connection between the BS and a specific MS and is unique for that specific MS, such a connection identifier can be referred to as a CON ID.

In some connection addressing techniques, a BS can use a MS ID to address an active MS. For example, a BS can include a MS ID in a message such as a signaling message or resource allocation message to indicate a designated MS. Some wireless networks can schedule data exchanges between a base station and one or more mobile station. In some implementations, when a MS is scheduled to receive or transmit data from/to BS, a BS can send one or more allocation messages to the MS that include a corresponding MS ID.

An allocation message can be implemented to include information describing a resource block for a MS. A MS can use allocation information to determine which data burst(s) in a frame are designated for the MS. For example, an allocation message can describe a location of a data burst within a frame. The allocation information can address a specific data burst to one or more mobile stations. In some implementations, allocation information for an OFDMA wireless communication system can include a subchannel index, OFDMA symbols offset, the number of subchannel, and the number of symbols allocated.

In one implementation, a frame can include one or more data bursts for a MS. A data burst can include one or more MAC PDUs. In some implementations, multiple MAC PDUs are concatenated into a data burst. A MAC PDU can include a header and a data payload. A header of a MAC PDU can include a CON ID. In some connection addressing techniques, a CON ID is included in the MAC PDU header to indicate to a MS which connection a MAC PDU belongs for each MAC PDU transmitted by a BS.

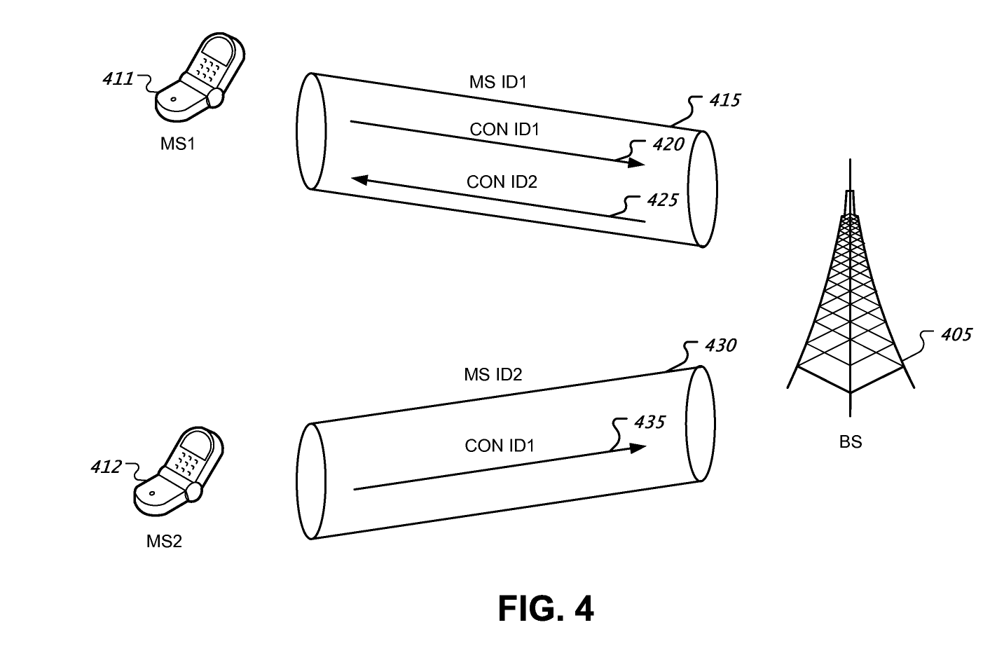

FIG. 4 shows an example of a connection addressing technique that uses a mobile station identifier. A base station 405 in a wireless network can use mobile station identifiers, e.g., MS ID1 and MS ID2, to identify different active mobile stations 411, 412 logically attached to the base station 405. A connection addressing technique can associate a first communication pipe 415 between the first mobile station 411 and the base station 405 with mobile station identifier MS ID 1. The first mobile station 411 can engage in multiple connections 420, 425 with the base station 405. In the first communication pipe 415, different connections 420, 425 are assigned different CON IDs, e.g., CON ID1 and CON ID2. A connection addressing technique can associate a second communication pipe 430 between the second mobile station 411 and the base station 405 with mobile station identifier MS ID2. The second mobile station 412 can engage in a connection 435 with the base station 405. In the second communication pipe 425, a connection 435 is assigned CON ID1.

A radio station such a mobile station 411, 412 or a base station 405 can use a mobile station identifier to differentiate between matching CON IDs that are in use and associated with different mobile stations. In FIG. 4, CON ID1 and CON ID2 are used to identify the connections for the first mobile station 411 and CON ID1 is used to identify the connection for the second mobile station 412. Here, each CON ID is only unique for a specific MS because the first and station mobile stations 411, 412 both carry connections that are identified by CON ID1. In some implementations, each connection is uniquely identified by a <MS ID, CON ID> pair in the scope of the base station 405.

In some implementations, a CON ID can identify a data flow. In some implementations, radio stations can carry information associated with a data flow over a connection and is uniquely identified with a combination address. A data flow can be referred to as a data stream. A combination address can include a MS ID and a CON ID.

Some wireless network designs can place different portions of a combination address into different frame locations with in a wireless communication. For example, a base station can include a MS ID starting at a first location within a frame and can include a CON ID starting at different subsequent frame locations for each connection that has data for delivery to a mobile station.

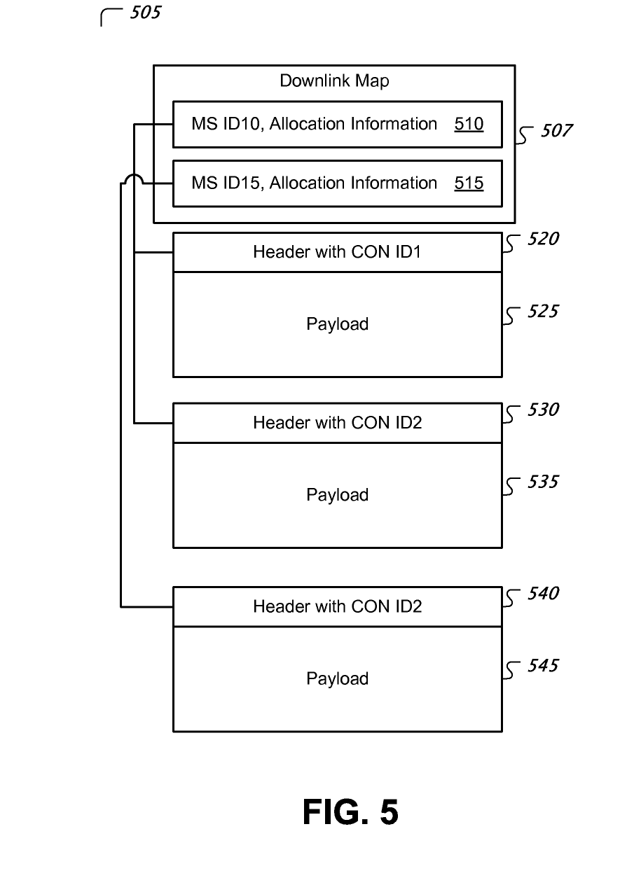

FIG. 5 shows an example of a frame that includes mobile station and connection identifiers. A frame 505 can include a downlink map 507. The downlink map 507 can include one or more information elements 510, 515 for different mobile stations. Information elements 510, 515 can include allocation information for a mobile station. Allocation information for a mobile station can include a MS ID to designate a specific mobile station for allocation information in an information element 510, 515.

For example, an information element 510 can include allocation information for a mobile station associated with MS ID10 that is indicative of one or more locations within the frame 505 that include information for the mobile station. The mobile station can use the allocation information to process a header 520 associated with a payload 525. The header 520 can include a connection identifier, e.g., CON ID1, that identifies the connection associated with the payload 525 to the mobile station.

The mobile station can process a second header 530 associated with a second payload 535. The second header 530 can include a connection identifier, e.g., CON ID2, that identifies the connection associated with the payload 535 to the mobile station. In some implementations, allocation information is indicative of a location of a data burst in the frame 505 and the data burst can include headers 520, 530 and corresponding data payloads 525, 535.

A different information element 515 can include allocation information for a mobile station associated with MS ID 15 that is indicative of one or more locations within the frame 505 that include information for the mobile station. The mobile station can use the allocation information to process a header 540 associated with a payload 545. The header 540 can include a connection identifier, e.g., CON ID2, that identifies the connection associated with the payload 540 to the mobile station.

In some implementations, a BS can send downlink map allocation messages to one or more mobile stations. A BS can include a MS ID in each allocation block in a downlink map message. A MS can decode or transmit based on the allocation block identified by the MS ID. Based on such an allocation block, MAC PDUs transmitted within the allocation block belong to connections related to the MS associated with the allocation block. Each MAC PDU is associated to a connection of the MS by a CON ID included in MAC header.

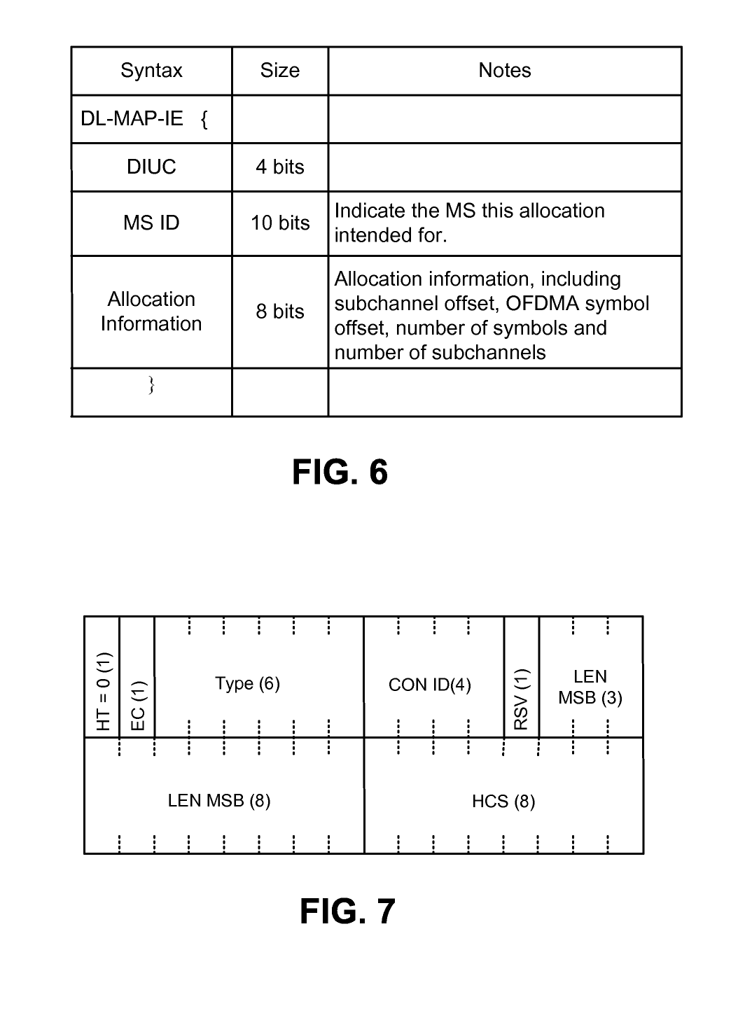

FIG. 6 shows an example of a downlink map information element that includes a mobile station identifier. A downlink map information element can include allocation information, and can include a MS ID to allocate one or more radio resources to a MS. Some wireless network implementations refer to a downlink map information element as a DL-MAP-IE. In some implementations, a DL-MAP-IE can include a Downlink Interval Usage Code (DIUC), a MS ID, and allocation information. Allocation information can include a subchannel offset, an OFDMA symbol offset, a number of symbols, and a number of subchannels. Different wireless networks can have different allocation information field sizes such as 8 bits or 32 bits, or other values.

FIG. 7 shows an example of a MAC header format that includes a CON ID field. Such a format can include the following fields HT, EC, payload type, CON ID, LEN, and HCS. In some implementations, the CON ID field length is 4 bits. Radio stations can use the CON ID value in a MAC header and an associated mobile station identifier to identify a connection.

Some wireless networks can use a MS ID field with a 10 bit length and a CON ID field with a 4 bit length. In a base station in such a wireless network, the base can specify 1000 active MSs and 16 connections per MS. In some implementations, a range of values in a MS ID field can be reserved for broadcast or multicast traffic.

A connection addressing technique can use mobile station identifiers for traffic types such as broadcast and multicast traffic. In some implementations, broadcast channel traffic can be identified using one or more MS IDs assigned to broadcast traffic. In some implementations, multicast channel traffic can be identified using one or more MS IDs assigned to multicast traffic. For example, a connection addressing technique can reserve MS ID 0 for one or more broadcast channels and can reserve MS ID 1 for one or more multicast channels. A connection addressing technique can identify multiple broadcast and multicast channels associated with respective broadcast and multicast identifiers. In some implementations, each broadcast channel and multicast channel can be uniquely identified using a <MS ID, CON ID> pair. For example, a base station can label broadcast channel as <MS ID0, CON ID0> and can label a multicast channel as <MS ID1, CON ID0>.

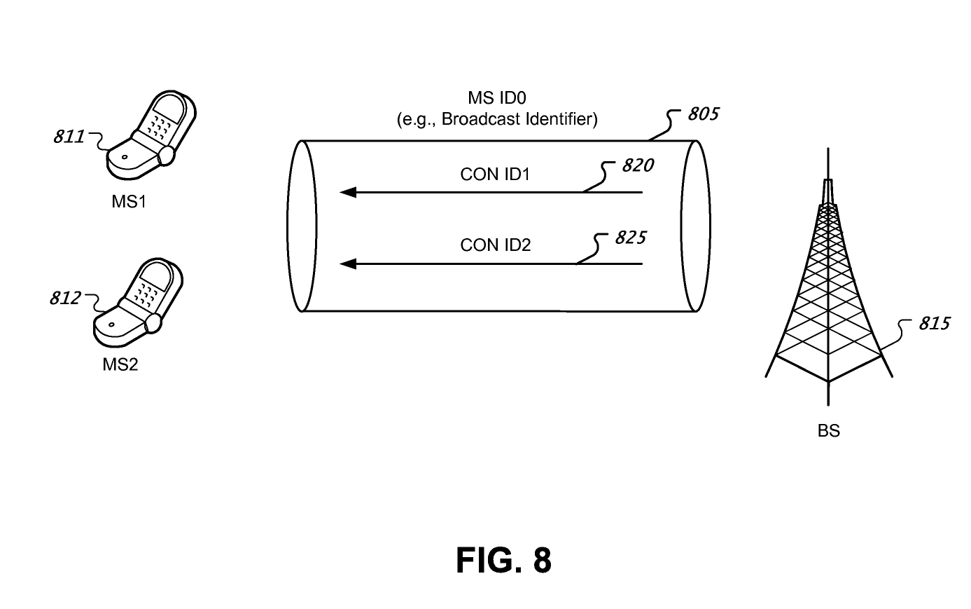

FIG. 8 shows an example of an addressing scheme that uses a mobile station identifier as a broadcast identifier. A base station 815 can reserve one or more values in a mobile station identifier field to be broadcast identifiers. In some implementations, a base station 815 can use a mobile station identifier to represent and identify broadcast traffic for multiple broadcast data flows. A communication pipe 805 can be associated with a broadcast identifier, e.g., MS ID0. The communication pipe 805 between a base station 815 and multiple mobile stations such as mobile stations 811, 812 can carry one or more data flows associated with one or more broadcast channels, respectively. The communication pipe 805 can use a connection identifier such as CON ID1 for a first broadcast channel 820 and CON ID2 for a second broadcast channel 825. A connection identifier associated with a broadcast channel can be referred to as a broadcast channel connection identifier.

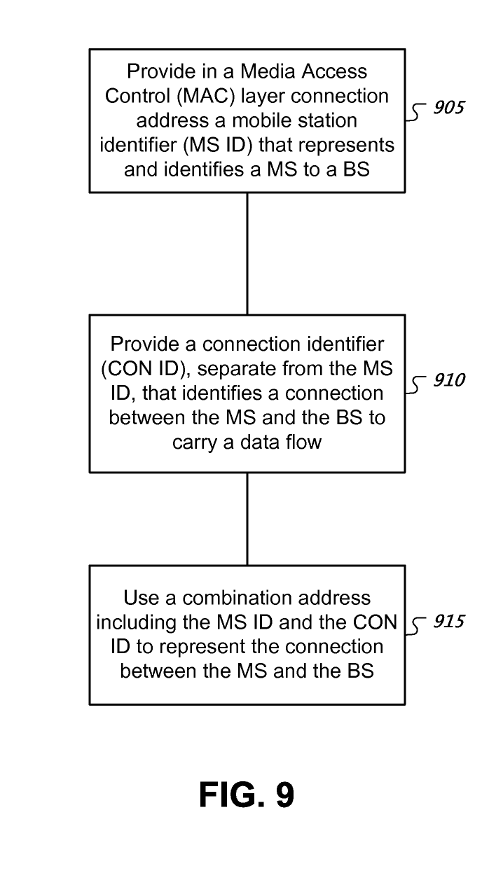

FIG. 9 shows an example of a connection addressing technique for wireless communications between radio stations. A connection address technique can provide in a Media Access Control (MAC) layer connection address a mobile station identifier (MS ID) that represents and identifies a mobile station to a base station of a wireless network (905). The technique can provide different mobile stations in communication with the base station being with different mobile station identifiers. The technique can provide a connection identifier (CON ID), separate from the MS ID, that identifies a connection between the mobile station and the base station to carry a data flow (910). The technique can provide different connections between the mobile station and the base station with different connection identifiers. Radio stations can use a combination address comprising the MS ID and the CON ID to represent the connection between the mobile station and the base station (915).

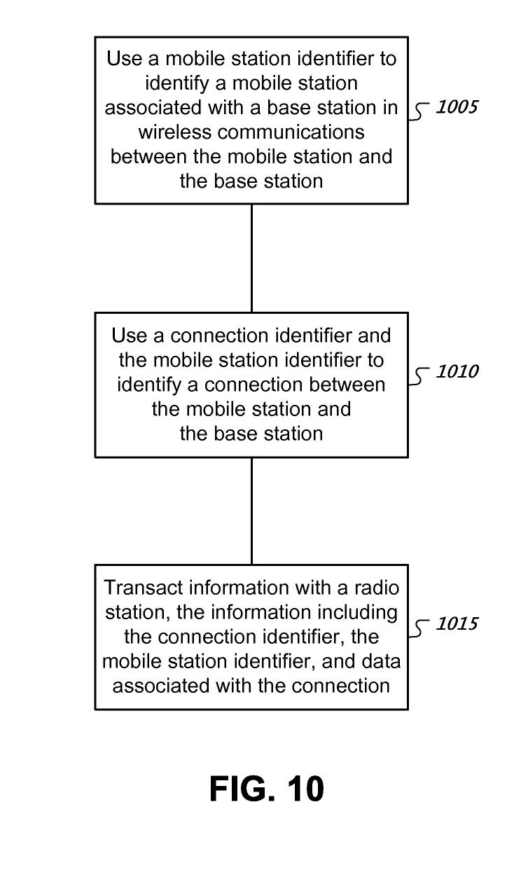

FIG. 10 shows a different example of a connection addressing technique for wireless communications between radio stations. A radio station can use a mobile station identifier to identify a mobile station associated with a base station in wireless communications between the mobile station and the base station (1005). The radio station can use a connection identifier and the mobile station identifier to identify a connection between the mobile station and the base station (1010). The radio station can transact information with a different radio station (1015). The information can include the connection identifier, the mobile station identifier, and data associated with the connection. Transacting information can include receiving a signal that includes the information. Transacting information can include transmitting a signal that includes the information.

Transacting information with a different radio station can include transacting, in a frame, information including a downlink map and one or more data bursts (1015). The downlink map can include the mobile station identifier. A data burst can include the connection identifier in a header portion and data in a payload portion. The downlink map can include frame location information that corresponds to the data burst.

The disclosed and other embodiments and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations may be made based on what is disclosed.

What is claimed is:

1. A method for wireless communications, comprising:
providing in a Media Access Control (MAC) layer connection address a mobile station identifier (MS ID) that represents and identifies a mobile station to a base station of a wireless network, each mobile station in communication with the base station being provided with a respective mobile station identifier;
providing a connection identifier (CON ID) that identifies a connection between the mobile station and the base station to carry a data flow and is a separate identifier from the MS ID for the mobile station for communications with the base station, each connection between the mobile station and the base station being provided with a respective connection identifier; and
using a combination address comprising the MS ID and the CON ID to represent the connection between the mobile station and the base station.

2. The method as in claim 1, further comprising:
using a second combination address, comprising the MS ID and a second CON ID, to represent a second connection between the mobile station and the base station to identify an additional data flow.

3. The method as in claim 1, further comprising:
including in a downlink map the MS ID and frame location information regarding one or more data bursts that are associated with the MS ID, at least one of the one or more data bursts comprising the CON ID; and
transmitting a signal to one or more mobile stations, the signal comprising the downlink map and the one or more data bursts.

4. The method as in claim 1, further comprising:
providing a specific mobile station identifier as a broadcast identifier to represent broadcast traffic from the base station to multiple mobile stations, the broadcast identifier being shared by the multiple mobile stations.

5. The method as in claim 4, further comprising:
providing a broadcast channel connection identifier that identifies a broadcast channel and is a separate identifier from the broadcast identifier; and
using a combination address comprising the broadcast identifier and the broadcast channel connection identifier to represent the broadcast channel.

6. The method as in claim 5, further comprising:
providing a second broadcast channel connection identifier that identifies a second broadcast channel and is a separate identifier from the broadcast identifier; and
using a second combination address comprising the broadcast identifier and the second broadcast channel connection identifier to represent a different broadcast channel.

7. The method as in claim 1, further comprising:
providing a specific mobile station identifier as a mutlicast identifier to represent mutlicast traffic from the base station to multiple mobile stations.

8. The method as in claim 7, further comprising:
providing a mutlicast channel connection identifier that identifies a mutlicast channel and is a separate identifier from the mutlicast identifier; and
using a combination address comprising the mutlicast identifier and the mutlicast channel connection identifier to represent the mutlicast channel to a group of mobile stations.

9. The method as in claim 8, further comprising:
providing a second mutlicast channel connection identifier that identifies a second mutlicast channel and is a separate identifier from the mutlicast identifier; and
using a second combination address comprising the mutlicast identifier and the second mutlicast channel connection identifier to represent a different mutlicast channel.

10. A method for wireless communications, comprising:
using a mobile station identifier to identify a mobile station associated with a base station in wireless communications between the mobile station and the base station;
using a connection identifier and the mobile station identifier to identify a connection between the mobile station and the base station; and
transacting information with a radio station, the information comprising the connection identifier, the mobile station identifier, and data associated with the connection.

11. The method as in claim 10, wherein transacting information with the radio station comprises transacting, in a frame, information comprising:
a downlink map that includes the mobile station identifier; and
a data burst that includes the connection identifier in a header portion, and data associated with the connection in a payload portion,
wherein the downlink map includes information that corresponds to a location of the data burst within the frame.

12. The method as in claim 10, further comprising:
using a second connection identifier and the mobile station identifier to identify a second connection between the mobile station and the base station, wherein the transacted information comprises data payload associated with the second connection and the second connection identifier in a header associated with the data payload.

13. The method as in claim 10, further comprising:
using a different mobile station identifier as a broadcast identifier to identify broadcast traffic; and
using a connection identifier associated with a broadcast channel and the broadcast identifier to identify the broadcast channel.

14. The method as in claim 13, wherein transacting information with the radio station comprises transacting, in a frame, information comprising:
a downlink map that includes the broadcast identifier;
a data burst that includes the connection identifier associated with the broadcast channel in a header portion, and data associated the broadcast channel in a payload portion,
wherein the downlink map includes information that corresponds to a location of the data burst within the frame.

15. The method as in claim 10, wherein the radio station is a mobile station and is identified by the mobile station identifier, wherein transacting information comprises receiving a signal that includes the information.

16. The method as in claim 10, wherein the radio station is a base station, wherein transacting information comprises transmitting a signal that includes the information to one or more mobile stations.

17. An apparatus for wireless communications, comprising:
transceiver electronics to communicate with one or more radio stations; and
processor electronics, in communication with the transceiver electronics, configured to perform operations, the operations comprising:
using a mobile station identifier to identify a mobile station associated with a base station in wireless communications between the mobile station and the base station;
using a connection identifier and the mobile station identifier to identify a connection between the mobile station and the base station; and
transacting information with a radio station, the information comprising the connection identifier, the mobile station identifier, and data associated with the connection.

18. The apparatus of claim 17, wherein transacting information with the radio station comprises transacting, in a frame, information comprising:
a downlink map that includes the mobile station identifier; and
a data burst that includes the connection identifier in a header portion, and data associated with the connection in a payload portion,
wherein the downlink map includes information that corresponds to a location of the data burst within the frame.

19. The apparatus as in claim 17, the operations further comprising:
using a second connection identifier and the mobile station identifier to identify a second connection between the mobile station and the base station, wherein the transacted information comprises data payload associated with the second connection and the second connection identifier in a header associated with the data payload.

20. The apparatus as in claim 17, the operations further comprising:
using a different mobile station identifier as a broadcast identifier to identify broadcast traffic; and
using a connection identifier associated with a broadcast channel and the broadcast identifier to identify the broadcast channel.

21. The apparatus as in claim 20, wherein transacting information with the radio station comprises transacting, in a frame, information comprising:
a downlink map that includes the broadcast identifier;
a data burst that includes the connection identifier associated with the broadcast channel in a header portion, and data associated the broadcast channel in a payload portion,
wherein the downlink map includes information that corresponds to a location of the data burst within the frame.

22. The apparatus as in claim 17, wherein the radio station is a mobile station and is identified by the mobile station identifier, wherein transacting information comprises receiving a signal that includes the information.

23. The apparatus as in claim 17, wherein the radio station is a base station, wherein transacting information comprises transmitting a signal that includes the information to one or more mobile stations.

24. A wireless communication system, comprising:
a plurality of base stations configured to provide wireless service,
each base station configured to use a mobile station identifier to identify a mobile station associated with the base station in wireless communications between the mobile station and the base station, use a connection identifier and the mobile station identifier to identify a connection between the mobile station and the base station, and transmit a signal to the mobile station, wherein the signal comprises the connection identifier, the mobile station identifier, and data associated with the connection.

25. The system as in claim 24, wherein the signal comprises information indicative of:
a downlink map that includes the mobile station identifier; and
a data burst that includes the connection identifier in a header portion, and data associated with the connection in a payload portion,
wherein the downlink map includes information that corresponds to a location of the data burst within a frame.

26. The system as in claim 24, the base station further configured to use a second connection identifier and the mobile station identifier to identify a second connection between the mobile station and the base station, wherein the signal comprises data payload associated with the second connection and the second connection identifier in a header associated with the data payload.

27. The system as in claim 24, the base station further configured to use a different mobile station identifier as a broadcast identifier to identify broadcast traffic, and use a connection identifier associated with a broadcast channel and the broadcast identifier to identify the broadcast channel.

28. The system as in claim 27, wherein the signal comprises information indicative of:
a downlink map that includes the broadcast identifier;
a data burst that includes the connection identifier associated with the broadcast channel in a header portion, and data associated the broadcast channel in a payload portion,
wherein the downlink map includes information that corresponds to a location of the data burst within a frame.
